(19) United States
(12) Patent Application Publication
(10) Pub. No.: US 2026/0086223 A1
(43) Pub. Date: Mar. 26, 2026

(54) Method and Object Tracking Unit for Sensor-Based Object Tracking and Correspondingly Configured Motor Vehicle

(71) Applicant: Bayerische Motoren Werke Aktiengesellschaft, Muenchen (DE)

(72) Inventors: Dominik KELLNER, Dachau (DE); Daniel MEISSNER, Friedberg (DE); Matthias STARK, Fuerstenfeldbruck (DE); Sascha STEYER, Pfaffenhofen a.d.Ilm (DE)

(21) Appl. No.: 19/110,871

(22) PCT Filed: Aug. 30, 2023
(86) PCT No.: PCT/EP2023/073837

§ 371 Date: Mar. 12, 2025

(30) Foreign Application Priority Data
Sep. 13, 2022 (DE) 10 2022 123 303.0

(51) Int. Cl. G01S 13/72; G01S 13/931

(52) U.S. Cl. CPC G01S 13/726; G01S 13/931; G01S 2013/93271

(57) ABSTRACT

A method and an object tracking unit for sensor-based object tracking and a correspondingly configured motor vehicle. In the method, objects which are only detected by a single one of multiple sensors are identified as single sensor objects. Corresponding object tracks, in which object data describing the respective object are stored, are then updated directly based on sensor data without using a predetermined filter. Other object tracks, to which no single sensor object was assigned, are updated based on the sensor data using the predetermined filter.

### BACKGROUND AND SUMMARY

The present disclosure relates to a method and an object tracking unit for sensor-based object tracking. The disclosure further relates to a correspondingly configured or equipped motor vehicle.

In various technical applications and sectors—for example, but not exclusively, in the vehicle and traffic sector—sensorial detection and tracking, thus tracking of objects in the respective surroundings, can be useful, for example, to avoid collisions, to plan trajectories, for monitoring, and/or the like. Since different types of corresponding sensors can have different advantages and disadvantages, multiple different sensors are often used and the sensor data or outputs thereof are combined with one another.

For example, a system for sensor data fusion for surroundings perception is described in DE 10 2021 113 653 B3. Specifically, a method is proposed therein for creating a surroundings model for a vehicle operated in a highly automated manner having at least two sensors for surroundings detection. The method therein comprises a projection of raw data of a first sensor on an occupancy grid by generating a grid cell dimension as a function of an inverse sensor model and a projection of preprocessed object data of a grid cell dimension as a function of an inverse sensor object model. The projected data are then fused to form an occupancy grid. A surroundings model is then created from grid data extracted therefront, which is provided for the highly automated operation of the vehicle. A corresponding surroundings model for vehicles having a high number of sensors ought therefore to be able to be created with minimized resources and with high trustworthiness and reliability.

As a further example, DE 10 2019 115 235 A1 describes object tracking in the blind spot. The method therein comprises identifying an object including points on the object and carrying out tracking of the object based on a movement model which contains a relationship of the points to one another. A position of one of the points in a blind spot is then output based on the tracking.

However, times of flight, latencies, and bandwidths for signal processing or data processing can often be problematic in previous approaches. For this purpose, DE 10 2018 105 293 A1 discloses a method for networked scene representation and expansion in vehicle surroundings in autonomous driving systems. The method therein comprises ascertaining data which relate to a position of a first object, and ascertaining a bandwidth and a latency time of a transmission channel. A part of the data is then transmitted in reaction to the bandwidth and the latency time of the transmission channel.

An object of the present disclosure is to enable reaction time-optimized object tracking.

This object is achieved by the present disclosure. Further possible embodiments of the disclosure are disclosed in the the description and the figures. Features, advantages, and possible embodiments which are described in the context of the description for one aspect of the present disclosure are to be viewed at least analogously as features, advantages, and possible embodiments of the respective subject matter of other aspects of the present disclosure.

The method according to the disclosure can be used in the scope of sensor-based object tracking, in particular in a correspondingly configured motor vehicle. However, the method according to the disclosure is not restricted in principle to this application. In the method according to the disclosure, sensor data of a sensor system are acquired in each measurement cycle. This sensor system comprises multiple individual sensors here, which can in particular be of different types. The individual sensors or the sensor system comprising them can already detect objects themselves and can track them over time or over multiple frames or measurement cycles. This can be carried out automatically, for example, by the sensor system or individual sensors in an internal data processing or preprocessing function. Sensor data originating from the sensor system or the individual sensors can also be acquired or processed accordingly, for example, by an object tracking unit configured for carrying out or applying the method according to the disclosure, thus, for example, a correspondingly configured control unit or the like, which is coupled or can be coupled to the sensor system or the individual sensors.

Furthermore, in the method according to the disclosure, objects detected in the sensor data or represented by these data are each assigned to an object track in which object data describing or characterizing the respective object are stored. Such an object track can thus be a respective object-specific data set or a data set created for a detected object. The detected objects or their data or properties can thus be retained or managed in the object tracks while the respective object is tracked. These object tracks can also be referred to as internal tracks, since they can be managed, for example, internally in the sensor system or sensors or within the object tracking unit close to the sensor along a corresponding signal or data processing pipeline.

Object properties or object statuses from the respective last or also preceding measurement cycles can be stored, for example, in an existing object track. A new object track can be created for newly detected objects. Due to the corresponding object recognition based on the acquired sensor data and the assignment to the object tracks, it is then known by which of the individual sensors a specific object was detected. This can also be stored in the object tracks.

Furthermore, the object tracks or the data or specifications on the objects stored therein are updated based on the sensor data corresponding to the correspondingly assigned objects from the respective current measurement cycle, thus based on the respective newest available or acquired sensor data. It can therefore be ensured that current data or specifications on the respective assigned object are or will be stored in the object tracks.

According to the disclosure, in the method, objects which were already detected for the first time before the respective current measurement cycle and are only detected in the respective current measurement cycle based on the respective current sensor data of precisely one of the multiple individual sensors, and which have been detected exclusively in or based on sensor data of only precisely this sensor since at least one predetermined time span comprising multiple measurement cycles, are identified or characterized or classified as single sensor objects. Such single sensor objects are thus objects which have only been detected by one and the same individual sensor at least within the predetermined time span. Only such objects are thus identified as single sensor objects. It can be provided that objects which were not detected within the predetermined time span and/or were detected for the first time or newly in the current measurement cycle or the like, for example, are also not identified as single sensor objects if they were previously or currently detected by only one single sensor. Other objects which were detected in the current measurement cycle and/or within the predetermined time span by multiple and/or changing ones of the individual sensors or were recognized in or based on sensor data of multiple different ones of the individual sensors, in contrast, can be identified, for example, as multisensor object tracks. If an object previously identified as a single sensor object, thus up to the respective current measurement cycle or point in time, is detected by at least one other sensor than previously in the current measurement cycle, the object can therefore immediately, thus still in the same current measurement cycle, lose its identification or classification as a single sensor object.

The predetermined time span can extend from the current point in time into the past, thus can be understood as a sliding time window. For example, the predetermined time span can be specified or defined in milliseconds or as a number of measurement cycles or the like. For example, the predetermined time span in an application in the vehicle sector can comprise, for example, 500 ms or 10 measurement cycles or the like. However, other values or lengths of the predetermined time span can also be used, for example, as needed, or depending on the application, typical measurement frequency of the sensors, speed or clock frequency of a signal processing unit or data processing unit, and/or the like.

Furthermore, it is provided according to the disclosure that object tracks to which no single sensor object was assigned or the data or specifications stored therein on the objects are automatically updated based on the sensor data corresponding to the assigned objects from the respective current measurement cycle, thus based on the respective newest available or acquired sensor data, using a predetermined filter or fusion mechanism. This can relate, for example, except for the single sensor object or the corresponding object tracks, to which a single sensor object was assigned, to all other or at least the other object tracks existing already before the current measurement cycle. The predetermined filter or fusion mechanism can be, for example, a Kalman filter or can comprise or apply such a filter. In principle, however, another filter or fusion mechanism or data filter can be applied, in particular if it effectively functions as a low-pass. The sensor data of multiple different sensors and/or data already stored in the respective object track and the sensor data from the respective current measurement cycle can be fused or combined with one another by the predetermined filter or fusion mechanism. Such filtering or fusing can include weighting of older and more current data. For uniform movements of detected objects, this can contribute to advantageously smooth and consistent tracking.

Furthermore, according to the disclosure, the object tracks to which a single sensor object was assigned are directly updated separately therefrom, thus from the other object tracks or those which are not linked with a single sensor object or independently of the filter or fusion method used for these, based on the sensor data corresponding to the assigned single sensor objects from the respective current measurement cycle, thus based on the respective newest available or acquired sensor data without using the predetermined filter, in particular without using any type of filter at all. In other words, objects or the associated data and object tracks can thus be processed or handled here differently depending on whether the respective object was detected by multiple sensors or was confirmed by a sensor different from the last or original sensor or whether the respective object only appears in the sensor data of a single sensor, that is, will be or is identified as a single sensor object.

In previous approaches or fusion systems in which sensor data of multiple sensors are fused, for example, by a Kalman filter, assigning, thus associating, and updating of existing object tracks typically takes place independently of which sensor or which sensors detect(s) or has or have already detected the respective object. Accordingly, sensor data can partially unnecessarily be filtered twice there, namely once internally in the sensor and a further time upon updating of the respective object track. This can include additional data processing effort and for nonuniform movements of an object, for example, in the event of braking or a merging process or the like, can generate additional filter latency, since, for example, a mean value or combination value is formed from the current sensor or object data and those corresponding to at least one preceding measurement. A reaction to correspondingly critical events, which are often accompanied by nonuniform movements, can accordingly take place with a delay, for example. Actual dynamics of the movement of the respective object can thus only be recognized in a damped or delayed manner due to the additional or double filtering. Moreover, the runtime or data processing time can increase nonlinearly with the number of detected objects or objects potentially to be assigned or with increasing number as an assignment target of object tracks potentially coming into consideration. For this purpose, for example, the Hungarian method—also called the Hungarian algorithm or Kuhn-Munkres algorithm—can be applied, which has a complexity of O(N³) in relation to the number N of the objects.

These problems can be at least partially addressed by the present disclosure. For this purpose, in the present disclosure, the single sensor objects or the corresponding sensor data are not filtered again for or during the updating of the respective object track. Nonuniform movements of the corresponding objects can thus accordingly be recognized earlier or more reliably. This in turn can enable correspondingly earlier or faster reactions to single sensor objects, thus objects which are detected by only one sensor, such as faster initiation of a braking maneuver or lane change or the like in the vehicle sector. The present disclosure can therefore contribute both to improved safety due to faster reaction times or lower latencies and also reduce a data processing effort and an associated energy consumption for the object tracking.

In one or more possible embodiments of the present disclosure, the sensors assign a sensor-specific identifier, which remains the same for the respective object over repeated detections of the same object by the respective sensor, to an object detected based on the respective sensor data. Such an identifier can be, for example, an identification number or the like. The respective object as well as the sensor which has detected the respective object is thus identified or specified by the respective identifier. The respective identifier is stored in the respective object track. The single sensor objects are then assigned, in particular exclusively, based on these identifiers to the respective object track for the respective object. The assignment or association of the single sensor objects detected by the sensors to the corresponding object tracks thus takes place here by the identifier, which the respective sensor leaves constant for a specific physical detected object—while it is tracked internally in the sensor—or by a corresponding comparison or matching between the identifier assigned to the respective object and also identifying the respective sensor and the identifiers stored in the object tracks. If, for example, in the respective current measurement cycle, an already known object, thus an object which has already been detected at least once at an earlier point in time, for which the object track is still stored, is detected again, it can be checked whether there is already or still the object track having the same identifier which was also assigned to this object from the respective object track. If so, the respective object can then be assigned directly to precisely this object track. This assignment or association can thus take place solely based on identifier, so that thus here, for example, no distance criterion is required or evaluated and no association or assignment of sensor data to multiple objects or of a specific object to multiple object tracks has to be calculated or the like. The one or more embodiments proposed here of the present disclosure therefore enables a particularly simple, low effort, rapid, and unambiguous or consistent assignment of single sensor objects to their object tracks.

In one or more further possible embodiments of the present disclosure, detected objects not identified as single sensor objects are assigned based on a predetermined distance metric to the object tracks. In particular a or the Mahalanobis distance can be used as such a distance metric. A corresponding object can thus be assigned, for example, to the object track for which the smallest distance results according to the predetermined distance metric. This can enable a reliable assignment even in complex situations in which, for example, multiple different sensors—possibly differently unique or differently strongly scattering—provide data on an object or the like.

In one or more further possible embodiments of the present disclosure, to update the object track for a single sensor object, dynamic properties of the respective single sensor object ascertained based on the associated current sensor data are overwritten in the respective object track for this single sensor object directly using corresponding values ascertained based on the current sensor data for the dynamic properties of the respective single sensor object. This direct overwriting of the corresponding data or values in the object track is thus carried out to update the respective object track here instead of the updating or fusing by a filter. This can be practically possible in particular if the individual sensors already carry out internal object tracking. Since no sensor data of a further or other sensor have to then be taken into consideration for a single sensor object, additional filtering or running through a fusion mechanism or the like would not offer an advantage and can therefore be saved in order to avoid corresponding data processing effort and accompanying delays. The updating can thus be carried out particularly rapidly, easily, and with little effort by the direct overwriting of the dynamic properties in the object tracks proposed here.

The dynamic properties can specify or comprise, for example, the status or corresponding status data of the respective single sensor object. For example, the position and/or the speed and/or the acceleration and/or the yaw angle and/or the yaw rate and/or the like of the respective single sensor object can be ascertained as dynamic properties. These can be ascertained or specified, for example, on a predetermined, in particular world-fixed, coordinate system or on the respective sensor or the sensor system or in the application of a motor vehicle, for example, relative to the motor vehicle equipped with the respective sensor or in relation to a vehicle coordinate system of the motor vehicle. Associated covariance matrices can be handled in the same manner jointly with the dynamic properties or status data.

In one or more further possible embodiments of the present disclosure, to update the object track at least for a single sensor object already detected at least once before the current measurement cycle, static properties of at least the respective single sensor object are adopted or maintained from older data or estimated over the time up to the respective current point in time. In the latter case, the correspondingly estimated values or properties can then be written or stored in the respective object track. Static properties in the present sense can be or comprise, for example, a classification, an age, a characterization with respect to the movement status as a stationary object or as a moving object, and/or the like. The age of an object can specify here, for example, at which point in time the respective object was initially detected. This can in particular be sensor-independent, since, for example, an initial detection of an object by a first sensor, such as a radar or the like, can take place, but the same object can be detected in the current measurement cycle or already over multiple measurement cycles, for example, only by another second sensor, such as a camera or the like. The age of such an object only detected by a second sensor in the current measurement cycle can then be determined or measured already from the first detection by the first sensor different therefrom.

The older data can be or comprise, for example, the object track already existing for the respective single sensor object or the data or specifications stored therein and/or older sensor data for the respective single sensor object. The older sensor data can originate here from the same sensor, by which the single sensor object was also detected in the respective current measurement cycle, or from one or more other sensors. In the latter case, the older sensor data or the static properties adopted or maintained in the respective current update can possibly originate from a time at which the respective object was not yet identified or classified as a single sensor object or was identified or classified as a single sensor object with respect to another sensor.

A type of data fusion can thus also take place for an object currently identified as a single sensor object, since the data or specifications stored in the respective object track can ultimately be based on sensor data originating from different sensors. This type of data fusion in which static properties determined from older sensor data of another sensor are adopted in the respective object track or maintained therein can be executable with substantially less effort and faster, however, than the filter-based fusion, for example, of current sensor data of multiple different sensors which was described at another point, as can be carried out, for example, for objects not identified as single sensor objects in the respective current measurement cycle. For such static properties, earlier or older information from other sensors can thus possibly be used, even if the respective single sensor object is not or was not detected in the current measurement cycle by this other sensor or these other sensors.

If a camera has already previously classified the object as a first sensor, for example, this classification, thus the corresponding static properties, is possibly not overwritten, even if the object is currently identified as a single sensor object only detected by another, second sensor, such as a radar or the like. This can avoid corresponding additional or doubled or multiple effort, for example, for a renewed determination of the respective static property. This procedure can at least be applied if the previous sensor which has already detected the respective object at an earlier point in time, thus lying before the current measurement cycle, is better suitable for determining the respective static property than the sensor by which the respective single sensor object was detected in the current measurement cycle. For this purpose, for example, a corresponding quality hierarchy of the various individual sensors can be specified for the various static properties. If the sensor by which the respective single sensor object is detected in the current measurement cycle is better suitable for determining a specific static property, this static property can possibly be overwritten in the respective object track, in particular in the event of a deviation. An always optimum or best possible management or monitoring, which is particularly low effort on average, however, of the static properties of single sensor objects can thus be enabled.

In one or more further possible embodiments of the present disclosure, upon the first update of an object track after the identification of the associated object as a single sensor object, dependencies on other sensors and/or other objects or object tracks are canceled. For example, one or more properties or data fields of the object or the respective object track and/or corresponding sensor-internal data, specifications, or links, such as a cross-correlation with another sensor or with other sensor data or with one or more other objects or object tracks or the like, can then be erased or reset to a predetermined standard value. The respective single sensor object or the respective object track of a single sensor object can thus be handled, that is, for example, managed or updated, independently and therefore particularly easily, with little effort, and rapidly.

In one or more further possible embodiments of the present disclosure, an object track for an existing single sensor object, which was thus already detected at an earlier point in time or in an earlier measurement cycle, is automatically directly erased if the respective single sensor object is not or was not output, thus detected or predicted, by the respective sensor for a predetermined time. For example, the method then possibly does not wait for further sensor data from another sensor or the evaluation thereof. It is thus possible to prevent objects from being taken into consideration or predicted further without corresponding sensor data being present as a foundation for this purpose. A data processing or management effort for the object tracking can thus be reduced and a probability of incorrect reactions due to objects which are no longer actually detected or reliably predicted can be reduced.

In a possible refinement of the present disclosure, the predetermined time comprises at least one measurement cycle of the respective sensor. An existing object, in particular a single sensor object, or the associated object track from the respective sensor or the sensor system can thus be maintained or retained or kept alive as a whole, for example, over at least one or precisely one measurement cycle in which the respective object is not detected. A respective sensor-internal logic or data management of the respective individual sensor can be used for this purpose. Externally to the sensor, the respective object track can then possibly be erased immediately or directly as soon as the respective sensor no longer outputs the object. The described advantages can thus be implemented particularly securely and reliably since the individual sensors can typically already have a functionality optimized for their respective mode of operation for tracking or predicting objects.

The present disclosure also relates to an object tracking unit, in particular for a motor vehicle. The object tracking unit according to the disclosure has a data processing unit for processing sensor data from multiple sensors. The object tracking unit according to the disclosure is configured here to carry out, in particular automatically, the method according to the disclosure. For this purpose, the object tracking unit or its data processing unit can have a processing unit, thus, for example, a microchip, microprocessor, or microcontroller or the like, and a computer-readable data memory coupled therewith. A corresponding operating or computer program can then be stored in this data memory, which codes or implements the method steps, measures, or sequences described in conjunction with the method according to the disclosure. This operating or computer program can then be executable by the processing unit in order to cause the corresponding method to be carried out. The object tracking unit according to the disclosure can in particular be the object tracking unit mentioned in conjunction with the method according to the disclosure or can correspond thereto. The object tracking unit according to the disclosure can comprise, for example, the sensor system mentioned in conjunction with the method according to the disclosure or can have an interface for direct or indirect coupling with such a sensor system or multiple individual sensors, for example, via an onboard network of a motor vehicle equipped with the object tracking unit.

The present disclosure also relates to a motor vehicle which has a sensor system having multiple different sensors for acquiring the surroundings and an object tracking unit according to the disclosure. The motor vehicle according to the disclosure can in particular be the motor vehicle mentioned in conjunction with the method according to the disclosure and/or in conjunction with the object tracking unit according to the disclosure or can correspond thereto.

Further features of the disclosure can result from the figures and the description of the figures. The features and combinations of features mentioned above in the description and the features and combinations of features shown hereinafter in the description of the figures and/or solely in the figures are usable not only in the respective specified combination, but also in other combinations or alone, without departing from the scope of the disclosure.

### BRIEF DESCRIPTION OF THE DRAWINGS

FIG. 1 shows a schematic representation of a motor vehicle which is equipped with a multisensor sensor system and is configured for optimized object tracking; and

FIG. 2 shows an exemplary schematic representation to illustrate a method for sensor-based object tracking.

### DETAILED DESCRIPTION OF THE DRAWINGS

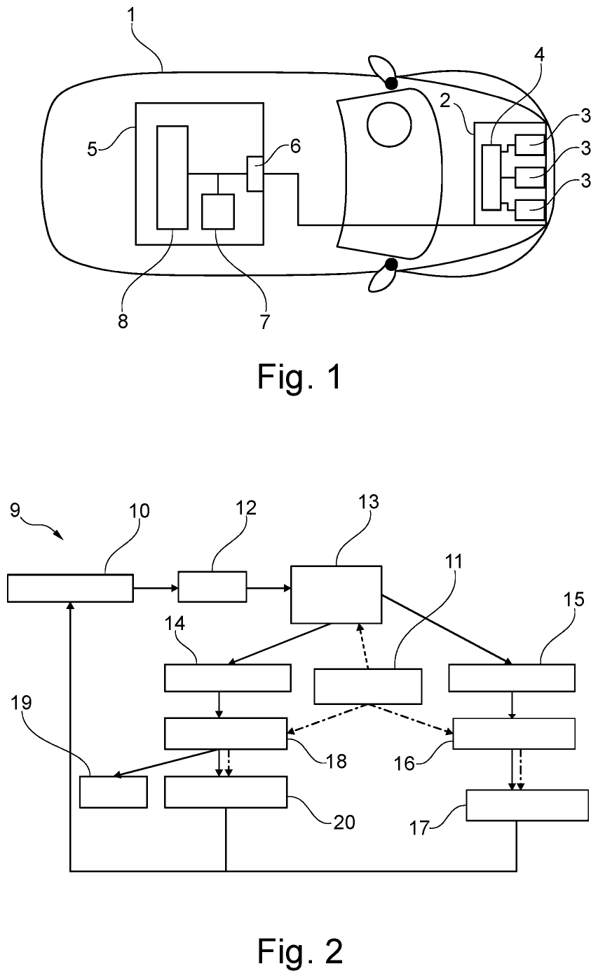

FIG. 1 shows an exemplary schematic representation of a motor vehicle 1, which is equipped with a sensor system 2 for acquiring the surroundings. The sensor system 2 comprises multiple individual sensors 3 here and, for example, also a preprocessing unit 4. Such a preprocessing unit 4 can also be integrated in each of the individual sensors 3. The individual sensors 3 can also be arranged spatially spaced apart from one another, thus at different points of the motor vehicle I. Furthermore, the motor vehicle 1 is equipped here with a schematically indicated object tracking unit 5 for object tracking, thus for tracking of objects detected by one or more of the sensors 3 in the respective surroundings of the motor vehicle 1. The object tracking unit 5 can be coupled, for example, via an interface 6 directly or via an onboard network of the motor vehicle 1 with the sensor system 2 or the individual sensors 3. The object tracking unit 5 can also be integrated into the sensor system 2 or combined therewith. By way of example and schematically, the object tracking unit 5 comprises a processor 7 here and a computer-readable data memory 8 for processing preprocessed sensor data of the individual sensors 3 provided by the sensor system 2.

For further illustration of the object tracking, FIG. 2 shows an exemplary schematic diagram 9. Object tracks 10 are represented therein, which can each contain, for objects detected by at least one of the sensors 3, data, specifications, properties, an identifier, which specifies the respective object and sensors 3 which have detected the object, and/or the like. An object track 10 thus represents a detected physical object and its properties, such as its position, speed, orientation, classification, and/or the like. The object tracks 10 can also each contain a data field in which it is specified or stored which sensor 3 or which sensors 3 have detected the respective object, for example, in the last 500 ms or 10 measurement cycles or the like or based on the sensor data of which of the sensor or sensors 3 the respective object track 10 was updated within the corresponding time. In each frame or measurement cycle, one or more of the sensors 3 can each provide object measured values which are already tracked internally in the sensor over time. The sensors 3 can thus not only track or estimate directly measured object properties, such as the position or orientation of the respective object, but also dynamic properties or status data, such as the speed or yaw rate or the like of the respective object over time. These data or properties can likewise be stored in the object tracks 10.

In a current measurement cycle, corresponding current sensor data 11 can be provided or acquired by one or more of the sensors 3. Some or all of the data or specifications stored in the object tracks 11 can then initially be predicted for the current point in time or the measurement or recording point in time of the current sensor data 11, that is, for example, extrapolated or developed or updated.

Based thereon and the respective current sensor data 11, a single sensor object identification 13 can then be carried out. For example, based on the mentioned data field, object tracks 10 can be identified which are exclusively to be updated based on the current sensor data 11 of a single one of the sensors 3 and, for example, were already exclusively updated based on sensor data 11 of precisely this sensor 3 for at least a predetermined time. In other words, detected objects, which have been seen or detected currently and already for at least a predetermined time span only by a single one of the sensors 3, can be identified here as single sensor objects and the associated object tracks 10 can be identified as single sensor object tracks 14. If camera data are acquired in a measurement cycle, for example, as current sensor data 11, all object tracks 10 can thus be identified as single sensor object tracks 14 which were updated within a predetermined time span extending into the past from the current point in time, for example, over the last 10 measurement cycles or the like, at least once, but exclusively based on sensor data 11 of the camera and not based on sensor data 11 of another sensor 3 or based on another object or sensor data 11 associated with another object or the like.

The other object tracks 10 as well as object tracks 10 possibly newly created in. the current measurement cycle or based on the current sensor data II, in contrast, can be identified as multisensor object tracks 15, for example.

Based on the current sensor data 11 and the multisensor object tracks 15, the remaining objects not identified as single sensor objects can be assigned in a first assignment method 16 to one of the multisensor object tracks 15 or—for an initial detection of an object in the current measurement cycle—to a respective new object track 10. In this first assignment method 16, a predetermined distance metric can be evaluated, for example, for the corresponding assignment or association between objects not identified as a single sensor object and multisensor object tracks 15.

The multisensor object tracks 15, to which an object detected in the current sensor data 11 was assigned here, can then be updated in a first updating method 17 based on the current sensor data 11. In particular a filter or fusion mechanism, for example, a predetermined Kalman filter or the like, is applied here.

Separately therefrom, a second assignment method 18 can be carried out for the single sensor objects and the corresponding single sensor object tracks 14, in order to assign each one of the single sensor objects to precisely one of the single sensor object tracks 14. In the second assignment method 18, a distance metric is not calculated and evaluated. Instead, the second assignment method 18 is based on a direct assignment based on the identifiers, which are stored in the mentioned data field and are also assigned to each detected object by the sensors 3 or the sensor system 2, for example, the preprocessing unit 4. The assignment between single sensor objects and single sensor object tracks 14 in the second assignment method 18 can thus be carried out by or based on corresponding identifier matching. Each of the object tracks 10 can store, for example, in the mentioned data field all identifiers which were allocated for this object by the sensors 3 which have detected the respective managed object within the or a predetermined time span. These identifiers identify here both the respective object and also the respective detecting sensor 3. If the identifier of a single sensor object thus corresponds to an identifier already stored in one of the object tracks 10, in the second assignment method 18, the respective single sensor object can readily be assigned directly to this single sensor object track 14.

If a single sensor object track 14 remains here, to which no single sensor object is assigned, this single sensor object track 14 can be directly erased automatically in the scope of an erasure 19. Since there was no corresponding assignment or association of a single sensor object with such a single sensor object track 14, this can include that the respective sensor 3 no longer outputs the respective single sensor object, thus has neither detected nor predicted it and moreover also none of the other sensors 3 has contributed sensor data 11 for the respective object track 10 within the predetermined time span, for example, within the last 500 ms or 10 measurement cycles or the like.

For the single sensor object tracks 14 to which a single sensor object was assigned in the current measurement cycle, in contrast, a second updating method 20 can be applied. This second updating method 20 does not use, in contrast to the first updating method 17, filters, in particular filters functioning as a low-pass or damping filters. Instead, dynamic properties or the statuses or status data of the respective single sensor object, which were determined, for example, directly by the respective sensor 3, for example, in the context of the preprocessing of corresponding sensor raw data, can be copied or written here possibly including corresponding covariance matrices directly from the current sensor data II into the respective single sensor object track 14.

Such dynamic properties can be or comprise manifold individual properties or values which can change dynamically, such as position, speed, acceleration, yaw rate, switched on or switched off status of a turn signal, hazard light, reversing light, brake light, and/or the like. Further data or properties can be determined, for example, based on the current sensor data 11 and data or properties already stored in the respective single sensor object track 14 and updated accordingly. This can relate, for example, to a movement status, thus a classification of the respective object as a moving or stationary object, a movement direction, an age, and/or the like. Static properties, such as a classification of the respective object and possibly semi-static properties, which typically change at most slowly in comparison to the dynamic properties, can likewise be handled or updated—for example, according to a corresponding specification—or can be maintained unchanged in the respective single sensor object track 14.

For an initial classification or identification of an object track 10 as a single sensor object track 14, possibly existing cross-correlations with other objects, sensors 3, or object tracks 10 can be erased or reset. For example, dependencies for the determination of measurement uncertainties or dependencies on another coordinate system of another one of the sensors 3 or the like can be erased or reset.

Correspondingly updated object tracks 10 then result as the result or output of the first updating method 17 and the second updating method 20 as the output basis for the next measurement cycle.

Overall, the examples described show how efficient single sensor tracking of objects can be implemented in a multisensor framework or system.

### LIST OF REFERENCE NUMERALS

1 motor vehicle
2 sensor system
3 sensors
4 preprocessing unit
5 object tracking unit
6 interface
7 processor
8 data memory
9 schematic diagram
10 object tracks
11 sensor data
12 prediction
13 single sensor object identification
14 single sensor object tracks
15 multisensor object tracks
16 first assignment method
17 first updating method
18 second assignment method
19 erasure
20 second updating method

1-10. (canceled)

11. A method for sensor-based object tracking, comprising:
acquiring, in each respective current measurement cycle, sensor data of a sensor system comprising multiple individual sensors;
assigning one or more objects represented in the sensor data to an object track that stores object data describing the one or more objects; and
updating the object tracks based on the sensor data corresponding to the assigned objects from the respective current measurement cycle,
wherein:
objects initially detected before the respective current measurement cycle and only detected in the respective current measurement cycle based on the sensor data of one of the multiple individual sensors, and which have been exclusively detected since at least one predetermined time span comprising multiple measurement cycles based on sensor data of this sensor, are identified as single sensor objects,
object tracks to which no single sensor object was assigned are updated based on the sensor data from the respective current measurement cycle using a predetermined filter, and
object tracks to which a single sensor object was assigned are directly updated separately based on the sensor data from the respective current measurement cycle without using the predetermined filter.

12. The method according to claim 11, wherein:
the sensors assign, to each object detected based on the respective sensor data, a sensor-specific identifier remaining uniform for the object over repeated detections of the object by the respective sensor, wherein the sensor-specific identifier is stored in the respective object track, and wherein the single sensor objects are assigned based on the sensor-specific identifiers to the respective object track.

13. The method according to claim 11, wherein:
objects not identified as single sensor objects are assigned based on a predetermined distance metric to the object tracks, the distance metric comprising a Mahalanobis distance.

14. The method according to claim 11, further comprising:
updating the object track for a single sensor object by directly overwriting, in the object track, dynamic properties of the respective single sensor object ascertained based on the current sensor data with corresponding values ascertained based on the current sensor data for the dynamic properties,
wherein the dynamic properties comprise one or more of: a position, a speed, an acceleration, a yaw angle, and/or a yaw rate.

15. The method according to claim 11, further comprising:
updating the object track for a single sensor object by adopting static properties of the respective single sensor object from older data or estimated over the time up to the respective current point in time.

16. The method according to claim 11, further comprising:
cancelling, upon first updating of an object track after the identifying of an object as a single sensor object, dependencies on other sensors and/or objects.

17. The method according to claim 11, further comprising:
automatically directly erasing an object track for an existing single sensor object if the respective single sensor object is not output by the respective sensor for a predetermined time.

18. The method according to claim 17, wherein:
the predetermined time comprises at least one measurement cycle of the respective sensor.

19. An object tracking unit for a motor vehicle, comprising:
a data processing unit for processing sensor data from multiple sensors, wherein the object tracking unit is configured to carry out a method comprising:
acquiring, in each respective current measurement cycle, sensor data of a sensor system comprising multiple individual sensors;
assigning each object represented in the sensor data to an object track in which object data describing the respective object are stored; and
updating the object tracks are updated based on the sensor data corresponding to the assigned objects from the respective current measurement cycle,
wherein:
objects already initially detected before the respective current measurement cycle and only detected in the respective current measurement cycle based on sensor data of one of the multiple individual sensors, and which have been exclusively detected since at least one predetermined time span comprising multiple measurement cycles based on sensor data of this sensor, are identified as single sensor objects,
object tracks to which no single sensor object was assigned are updated based on the sensor data from the respective current measurement cycle using a predetermined filter, and
object tracks to which a single sensor object was assigned are directly updated separately based on the sensor data from the respective current measurement cycle without using the predetermined filter.

20. The object tracking unit according to claim 19, wherein:
the sensors assign, to each object detected based on the respective sensor data, a sensor-specific identifier remaining uniform for the object over repeated detections of the object by the respective sensor, wherein the sensor-specific identifier is stored in the respective object track, and wherein the single sensor objects are assigned based on the sensor-specific identifiers to the respective object track.

21. The object tracking unit according to claim 19, wherein:
objects not identified as single sensor objects are assigned based on a predetermined distance metric to the object tracks, the distance metric comprising a Mahalanobis distance.

22. The object tracking unit according to claim 19, further comprising:
updating the object track for a single sensor object by directly overwriting, in the object track, dynamic properties of the respective single sensor object ascertained based on the current sensor data with corresponding values ascertained based on the current sensor data for the dynamic properties,
wherein the dynamic properties comprise one or more of: a position, a speed, an acceleration, a yaw angle, and/or a yaw rate.

23. The object tracking unit according to claim 19, further comprising:
updating the object track for a single sensor object by adopting static properties of the respective single sensor object from older data or estimated over the time up to the respective current point in time.

24. The object tracking unit according to claim 19, further comprising:
cancelling, upon first updating of an object track after the identifying of an object as a single sensor object, dependencies on other sensors and/or objects.

25. The object tracking unit according to claim 19, further comprising:
automatically directly erasing an object track for an existing single sensor object if the respective single sensor object is not output by the respective sensor for a predetermined time.

26. The object tracking unit according to claim 25, wherein:
the predetermined time comprises at least one measurement cycle of the respective sensor.

27. A motor vehicle, comprising:
a sensor system having multiple different sensors for acquiring surroundings of the motor vehicle; and
an object tracking unit comprising:
a data processing unit for processing sensor data from multiple sensors, wherein the object tracking unit is configured to carry out a method comprising:
acquiring, in each respective current measurement cycle, sensor data of a sensor system comprising multiple individual sensors;
assigning each object represented in the sensor data to an object track in which object data describing the respective object are stored; and
updating the object tracks are updated based on the sensor data corresponding to the assigned objects from the respective current measurement cycle,
wherein:
objects already initially detected before the respective current measurement cycle and only detected in the respective current measurement cycle based on sensor data of one of the multiple individual sensors, and which have been exclusively detected since at least one predetermined time span comprising multiple measurement cycles based on sensor data of this sensor, are identified as single sensor objects,
object tracks to which no single sensor object was assigned are updated based on the sensor data from the respective current measurement cycle using a predetermined filter, and
object tracks to which a single sensor object was assigned are directly updated separately based on the sensor data from the respective current measurement cycle without using the predetermined filter.

28. The motor vehicle of claim 27, wherein:
the sensors assign, to each object detected based on the respective sensor data, a sensor-specific identifier remaining uniform for the object over repeated detections of the object by the respective sensor, wherein the sensor-specific identifier is stored in the respective object track, and wherein the single sensor objects are assigned based on the sensor-specific identifiers to the respective object track.

29. The motor vehicle of claim 27, wherein objects not identified as single sensor objects are assigned based on a predetermined distance metric to the object tracks, the distance metric comprising a Mahalanobis distance.

30. The motor vehicle of claim 27, further comprising:
updating the object track for a single sensor object by directly overwriting, in the object track, dynamic properties of the respective single sensor object ascertained based on the current sensor data with corresponding values ascertained based on the current sensor data for the dynamic properties,
wherein the dynamic properties comprise one or more of: a position, a speed, an acceleration, a yaw angle, and/or a yaw rate.
